(19) United States
(12) Patent Application Publication
(10) Pub. No.: US 2002/0023175 A1
(43) Pub. Date: Feb. 21, 2002

(54) METHOD AND APPARATUS FOR EFFICIENT, ORDERLY DISTRIBUTED PROCESSING

(76) Inventor: BRIAN R. KARLAK, OAKLAND, CA (US)

Correspondence Address: CHARLES E GOTLIEB, 540 UNIVERSITY AVENUE, SUITE 300, PALO ALTO, CA, 94301

(21) Appl. No.: 08/868,877

(22) Filed: Jun. 4, 1997

(51) Int. Cl. G06F 9/46; G06F 9/44

(52) U.S. Cl. 709/314; 709/317

(57) ABSTRACT

A method and apparatus operates multiple applications via an operating system using a set of instructions, and formats the results of several applications into a common format. The applications can reside on one or more computer systems and may be operated by placing objects into a queue and allowing application interfaces that run the applications to retrieve the objects from the queue when the application is available for operation. The instructions can specify conditions based on the results of one or more of the applications and the method and apparatus change the execution flow of the instructions based on these conditions and the results produced. In addition, the results from multiple applications may be placed into a common database for subsequent processing.

### FIELD OF THE INVENTION

The present invention relates to computer software, and more specifically to the control of computer software by other computer software.

### BACKGROUND OF THE INVENTION

Computer software applications may be used to analyze data. The user of the application either provides the application with data or the location of the data, and operates the application to process the data to produce one or more results.

Where a task is complex, a single application may not exist to fully perform the task, requiring the use of multiple applications. Some or all of the multiple applications may process the same set of data, Dr some of the applications may process different sets of data.

The use of one application to perform a task may be dependent on the results of one or more earlier applications. For example, a researcher who desires to identify the probability of a match in biological sequence data of a certain unknown protein sequence with that of known protein sequences stored in one or more databases may wish to analyze the unknown sequence data against several databases of protein sequences. Each database may be analyzed using any of several applications, each of which may use a different algorithm. The researcher may first wish to try less sophisticated applications which operate quickly, but may not identify as many potential matches as other more sophisticated applications which operate more slowly. For each set of unknown sequence data, the researcher may wish to use increasingly sophisticated applications until a match with sufficient probability is identified by the current application or until no more sophisticated applications are available to process such data.

The process of using multiple applications can be time consuming. The user is required to run an application and may need to review the result before proceeding to run the next application. Additionally, the results produced by each application can number hundreds or thousands of pages of printed information, requiring a lengthy review process before proceeding to the next step. Some applications are themselves time consuming to operate and even the slightest input syntax error can corrupt the results, requiring the application to be rerun. The length of time which a user is required to operate an application and analyze the results can result in high costs of performing the task, can slow the completion of the task, and can make large tasks prohibitively expensive or time consuming.

The person who operates the applications to perform the task must be trained on the use of each application, driving up the costs of the task, or prohibiting the use of certain applications due to lack of training on their operation by available personnel. Further, if certain applications may be prone to error, an additional person is required to review the work of the person who performed the task to ensure it was performed properly.

The same or similar task may need to be repeated many times by the user. The task may be repeated because some of the databases have been updated, because different data is required to be similarly analyzed or because a slightly different result is required. A single change can result in many hours of repetitious work as the task is performed again, multiplying the drawbacks of the task, reducing the morale of the individual performing the task, with the likelihood of increased cost, time and error as the result.

Batch control programs have been developed to partially automate the numerous steps which may be required to perform a task. However, conventional batch control programs do not fully automate the procedure where the execution flow of the sequence of batch instructions depends on interpretation of the results of one or more of the applications executed by the batch instructions. In addition, interpreting the results of what may be numerous files output as results from the various applications controlled, each file with a different format, inconsistent terminology and inconsistent standards, remains a time consuming, error-prone task requiring the services of an expert.

It is desirable to more completely automates the task of operating and interpreting the results of multiple applications.

Where the automation of this task will be implemented in one or more computers, the architecture and management approach used to implement the automation can affect the operation of the automation. For example, a conventional monolithic architecture may be used as described herein to automate the operation of the applications. However, where the applications to be automated are computationally intensive, a monolithic architecture may be suboptimal because of the length of time required to complete the automated task, or the cost of the computer system required to more rapidly execute the applications.

A distributed architecture, with multiple computers coupled via a local area network or the Internet can allow the applications to be operated simultaneously, lowering the time it takes to complete the automated task for a given cost. However, to minimize the time required to complete the automated task, added complexity to control the operation of each of the computers in the distributed architecture may be implemented.

For example, conventional spooler techniques may be used to control the operation of multiple machines arranged in a distributed architecture. Using a conventional spooler, each subtask is assigned to a machine in the distributed architecture that can perform the subtask by a process known as a spooler. The spooler directs the operation of many machines in the distributed architecture. A description of the subtask is placed by the spooler process in one of several queues. Each of these queues is dedicated to one machine that processes subtasks. When a machine completes processing one subtask, it takes another one from the queue dedicated to it. If the queue is empty, the machine to which the queue is dedicated waits for another subtask to be placed in the queue.

The spooler is responsible for spreading the subtasks across the machines that can perform that subtask, providing a high throughput of subtasks but increasing the complexity of the spooler. Furthermore, if one machine stops operating, the spooler must reassign all of the subtasks previously assigned to that machine to the queues of other machines that can process the subtask, requiring the spooler to actively monitor the operation of each of the other machines, preventing the machine containing the spooler from performing other useful work.

The use of even a complex, continuously operating spooler can cause subtasks to be performed out of the order they were assigned. For example, four subtasks S1, S2, S3 and S4 may be alternately directed by the spooler to the queues of machines A and B in the order in which the subtasks are received by the spooler. S1 is spooled to machine A, S2 to machine B, S3 to machine A and S4 to machine B. If subtask S2 is relatively short compared to subtask S1, machine B will execute subtask S4 before machine A executes subtask S3. Where it is desirable that all subtasks executable by a machine be executed in the order received, a spooler process is undesirable.

It is desirable to identify a management mechanism for a distributed architecture for processing subtasks that does not require the complexity of a spooler, yet spreads subtasks to multiple machines in an orderly manner.

### SUMMARY OF INVENTION

A method and apparatus accepts, stores and executes instructions to operate multiple applications. Each instruction can direct the execution of one or more applications, and provide conditional instructions that change the flow of execution of the instructions based on the results of the applications executed. Results of the applications can be adapted to a consistent format and placed into a database for subsequent processing or review by the user or others. The results may be presented to the user in summary form for rapid interpretation, but linked to additional data to easily allow the user full access to the results of each application.

The operation of multiple applications may be implemented using a monolithic architecture of a single computer system, or using multiple computers arranged using a distributed architecture. Where a distributed architecture is employed, identifiers of subtasks are placed in a single queue for all subtasks desired by a process, and the identifier is associated with an indicator describing the type of computer that can run the application or applications required to complete the subtask. An agent in each computer that executes one or more applications maintains the type of the computer on which it resides. When the agent determines that the computer is ready to accept another subtask, it queries the single queue, and, starting at the head of the queue, searches for a subtask associated with a computer type that matches the type it maintains. If it finds such a subtask, the agent retrieves the identifier for execution by applications on the computer on which the agent resides. If the agent does not find such a subtask with a matching type, the agent can search the queues of other processes. If no such subtasks are identified, the agent can search again starting with the first queue after waiting a period of time. In this manner, all of the subtasks associated with a process are executed in the order desired by the process without requiring the complexity of a centralized management arrangement.

### BRIEF DESCRIPTION OF THE DRAWINGS

FIG. 1 is a block schematic diagram of a conventional computer system.

FIG. 2A is a block schematic diagram of a controller for operating multiple applications which use one or more input and/or database files according to one embodiment of the present invention.

FIG. 2B is a block schematic diagram of an alternate embodiment of the controller of FIG. 2A for operating multiple applications residing on separate computer systems according to one embodiment of the present invention.

FIG. 3A is a block schematic diagram of a strategy step according to one embodiment of the present invention.

FIG. 3B is a textual representation of the strategy step of FIG. 3A according to one embodiment of the present invention.

FIG. 4 is a block schematic diagram of an application interface according to one embodiment of the present invention.

FIG. 5A is a block schematic diagram of a distributed architecture of four computers which operate or execute multiple applications according to one embodiment of the present invention.

FIG. 5B is a block schematic diagram of a distributed architecture of five computers which operate or execute multiple applications according to an alternate embodiment of the present invention.

FIG. 6 is a block schematic diagram of an agent according to one embodiment of the present invention.

FIG. 7A is a flowchart illustrating a method of operating multiple applications using a strategic according to one embodiment of the present invention.

FIG. 7B is a flowchart illustrating a method of operating an application according to one embodiment of the present invention.

FIG. 7C is a flowchart illustrating a method of operating multiple applications using a strategy according to an alternate embodiment of the present invention.

FIG. 7D is a flowchart illustrating a method of operating multiple applications using a strategy according to an alternate embodiment of the present invention.

FIG. 8 is a flowchart illustrating a method of providing an instruction to an application according to one embodiment of the present invention.

FIG. 9A is a flowchart illustrating a method of executing operational instructions according to one embodiment of the present invention.

FIG. 9B is a flowchart illustrating a method of executing operational instructions according to an alternate embodiment of the present invention.

### DETAILED DESCRIPTION OF A PREFERRED EMBODIMENT

1. Architecture of a Conventional Computer System

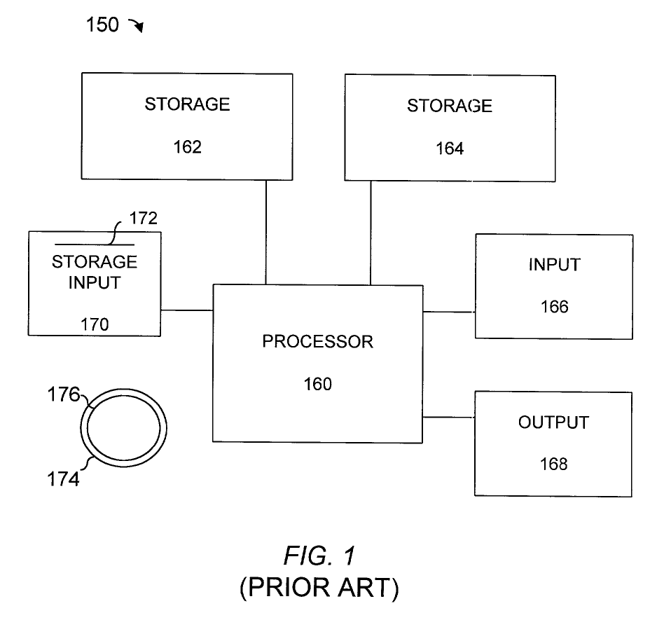

The present invention may be implemented as software on one or more conventional computer systems. Referring now to FIG. 1, a conventional computer system 150 for practicing the present invention is shown. Processor 160 retrieves and executes software instructions stored in storage 162 such as memory which may be Random Access Memory (RAM) and may control other components to perform the present invention. Storage 162 may be used to store software instructions or data or both. Storage 164, such as a computer disk drive or other nonvolatile storage, may also provide storage of data or software instructions or both. In one embodiment, storage 164 provides longer term storage of instructions and data, with storage 162 providing storage for data or instructions that may only be required for a shorter time than that of storage 164. Input device 166 such. as a computer keyboard or mouse or both allows user input to the system 150. Output 168, such as a display or printer, allows the system to provide information such as instructions, data or other information to the user of the system 150. Storage input device 170 such as a. conventional floppy disk drive or CD-ROM drive accepts via input 172 computer program products 174 such as a conventional floppy disk or CD-ROM that may be used to transport computer instructions or data to the system 150. Each computer program product 174 has encoded thereon computer readable code devices 176, such as magnetic charges in the case of a floppy disk or optical encodings in the case of a CD-ROM which are encoded to configure the computer system 150 to operate as described below.

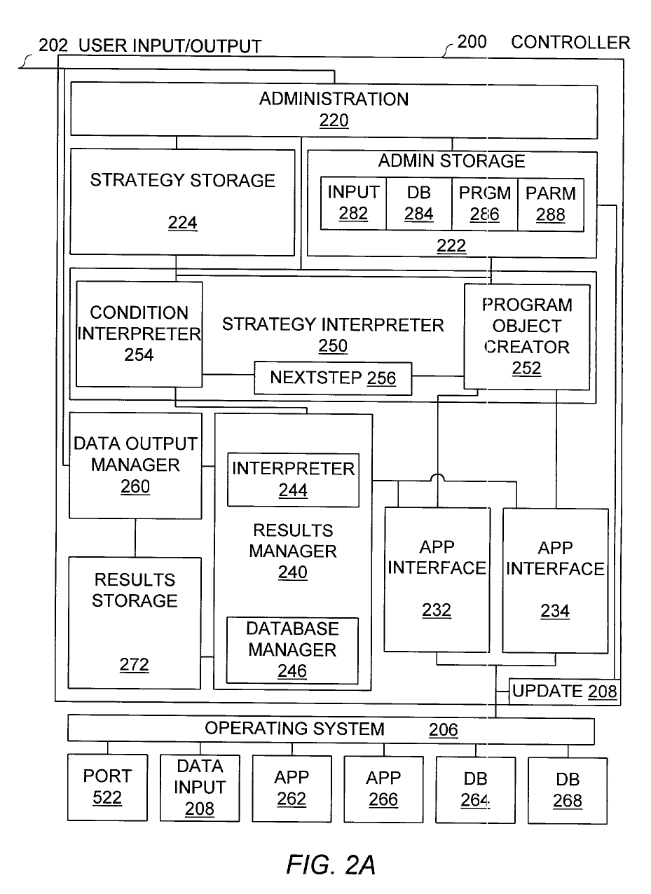

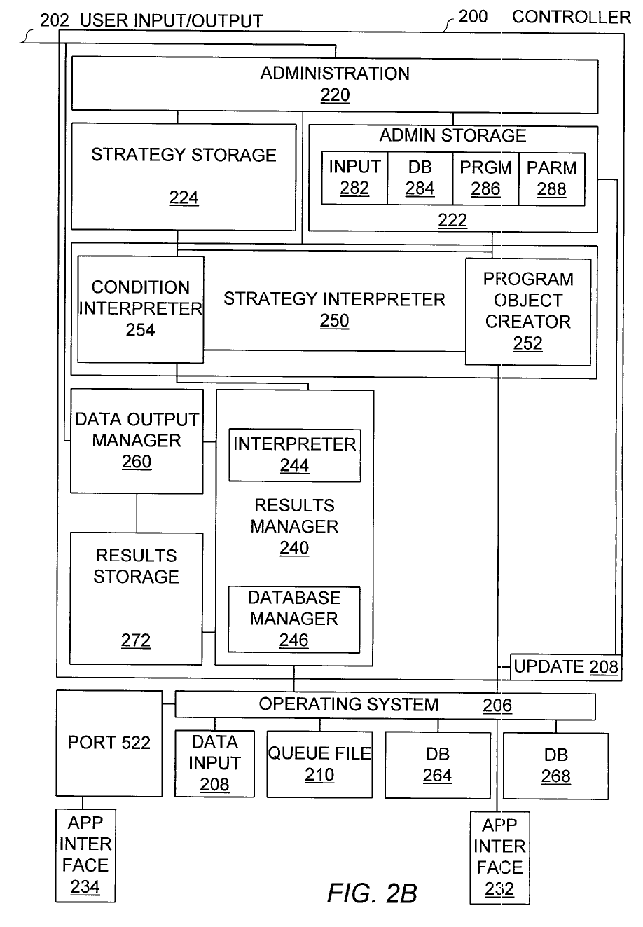

Referring now to FIG. 2A, a multiple application controller 200 according to one embodiment of the present invention is shown. For purposes of example, two applications 262, 266 are controlled by the multiple application controller 200, however, any number of applications may be controlled. Each application 262, 266 may have a corresponding data source 264, 268, for example, an protein or nucleotide sequence database which is used by the application 262, 266 to identify sequence homology of an unknown protein sequence described by data in a. data input file 208. The applications 262, 266, databases 264, 268 and input file 208 are coupled to the controller 200 via operating system 206. In one embodiment, the applications 262, 266, databases 264, 268, input file 208 and controller 200 reside on a single computer system in one embodiment, or on multiple computer systems in an alternate embodiment. The applications 262, 266 databases 264, 268, input file 208 and controller 200 may reside in any of the storage devices of these one or more computer systems.

2. User Input/Output

The user interacts with the multiple application controller 200 using user input/output 202, which may be coupled to a keyboard, mouse and monitor combination, as well as a hardcopy device such as a printer and/or a plotter.

3. Strategy Definition and Storage

a. Strategies-Overview

A user directs the operation of the controller 200 by defining one or more strategies, specifying one or more input records or input files and then directing the controller 200 to run one or more of the strategies defined against the inputrecords or files. In one embodiment, a strategy is a set of instructions known as “steps” that define how programs which correspond to applications 262, 266 as described below will be operated by the controller 200. Each input may be a file in one embodiment, or may be a portion of a file, such as a database record, in another embodiment.

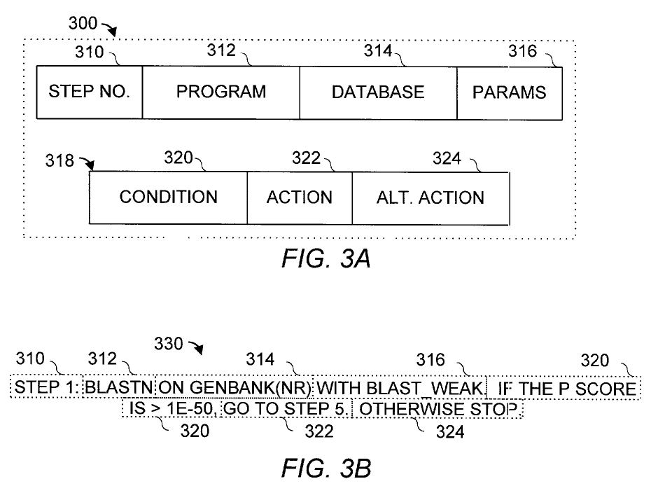

In one embodiment, each strategy step operates a program, and may provide instructions regarding which step, if any should be operated next. Referring now to FIG. 3A a form of strategy step 300 according to one embodiment of the present invention is shown. Each strategy step may contain some or all of the components 310, 312, 314, 316, 320, 322, 324 shown in FIG. 3A. A description of each component 310, 312, 314, 316, 320, 322, 324 may be illustrative.

In one embodiment, each step 300 has a step number 310 with the first step starting with ‘1’, the next step having a step number of ‘2’ and so on. The step number 310 provides a reference to the step 300 for use as described below.

Each step 300 operates a program, described below. To operate the program, the controller 200 may communicate directly with the program in one embodiment, or may communicate with another program or process, such as CORBA-compliant middleware as described below, by transmitting an object which is used to operate the program. The program, described below, operated by the step is described by program name 312.

In one embodiment, some or all of the programs that may be operated require certain inputs and the strategy step 300 specifies some or all of the inputs that are to be provided to the program having the name 312 when it is executed. In one embodiment, some of the programs use a database as one input, and may use parameters from a command line input. Database name 314 and parameter set name 316 are identified in the strategy step 300 to be provided to the program named in program name 312 when the strategy step 300 is executed. In one embodiment, each strategy step 300 may use input data such as sequence data in an input file, and this input is not a part of each step, but is defined once for the entire strategy. In one embodiment, the input record or input file is a part of the strategy. In another embodiment, the input record or file is not a part of the strategy, but is entered by the user so that a strategy can be applied to any one or more of a number of inputs.

The program name 312, database name 314 and parameter set name 316 make up the operational portion of the step 300. In one embodiment, the details about the program corresponding to the program name 312, the database corresponding to the database name 314 and the parameter set corresponding to the parameter set name 316 are defined and stored elsewhere as described below.

In one embodiment, each strategy step 300 Contains conditional branch directions 318 regarding what to do after the program specified by program name 312 has been executed and any results produced. The directions 318 can include a condition 320, an action 322 to be taken if the condition 320 is met, and an action 324 to be taken if the condition 320 is not met. If an action 322 is to be taken unconditionally, condition 320 and alternate action 324 are omitted and only the action 322 is specified in the step.

In one embodiment, the condition 320 may be a “case” statement similar to case statements in the Pascal programming language, and action 322 and alternate action 324 can specify more than two alternate actions that are to be taken based upon the result of the case statement specified in the condition 320 portion of the step 300.

The action 322 and the alternate action 324 may each specify either a strategy step to be executed, or the command “stop” which means that no further strategy steps should be executed as a part of the strategy.

In another embodiment, a strategy step can contain or omit any number of the elements 310, 312, 324, 316, 320, 322, 324 described above. For example, an unconditional step may omit the conditional branch directions 318. The program 318, database 314 and parameters 316 may be omitted, and the condition 320 may refer to a result of an earlier step, or even the occurrence of an event unrelated to the strategy such as the time of day so as to control the strategy flow. In one embodiment, the step number may be omitted and each step may be represented by an icon for reference instead of a step number.

Referring now to FIG. 3B, an example of a strategy step according to one embodiment of the present invention is shown with each component part 310, 312, 314, 316, 320, 322, 324 corresponding to the parts described with reference to FIG. 3A displayed. The strategy step 330 is step number 1, and directs the operation of a program “blastn” using the database “Genbank” and a parameter set of “blast_weak”. If any of the results from the blastn program have a “P Score” described below that is above 1e⁻⁵⁰, the next step in the strategy that the controller will execute will be step 5, not shown, and otherwise execution of the strategy terminates.

b. Definitions

Referring again to FIG. 2A, in one embodiment, details of certain of the components of each strategy step are defined to the controller 200 by a user via user input/output 202 using administration 220. The user then creates each strategy step using these defined components. Thus, the components operate like building blocks. The user defines the components, and uses them to build strategy steps. The user defines a sequence of strategy steps to build a strategy, and the strategy may be run against one or more inputs. The definition of the inputs and components of strategy steps is made in the following manner in one embodiment of the present invention.

In one embodiment, the user defines each input to the controller 200. Each input may be a database record of a single file in one embodiment, or may be a separate file in another embodiment.

If each input is a separate file, an identifier of each input file 208 that may be defined in a strategy is input by the user to the administration 220. The location and filename of the input file 208 is also input to the administration 208. Administration 208 stores the identifier, location and filename in an input file table 282 in the administration storage 222, which may be any storage device or combination of devices. In one embodiment, the type of information in or format of the file is described by the user and administration assigns a type identifier to the file and stores the identifier in the input file table 222 for use as described below. All of the information for each file is stored together or otherwise associated in the input file table 222.

If the input is a database record, the user may assign a name to the input record, and administration assigns an integer identifier to the record and records the name of the input file 208 containing the database, as well as other location identifiers such as table name. Administration 220 may be used to input the input records as well. In one embodiment, the type of data is also stored with each data record, allowing for automatic selection of the proper program that matches the type of the data as set forth below.

In one embodiment, the user similarly defines each database 264, 268 to the controller 200. The user inputs via user input/output 202 the details about each database 264, 268 such as an identifier by which the database 264, 268 will be identified, type of result that can be produced from the database 264, 268, format or formats to which the database complies, location and/or filename of the file that contains the database 264, 268 and whether the database is regularly updated as described below. In one embodiment, each database so defined is assigned a unique identifier by the administration 220. A type code defining the type of information stored in or the format of the database file 264, 268 may also be defined by the user to administration 220. This information for each database 264, 268 is stored together or otherwise associated by administration 220 into database table 284 of administration storage 222 for use as described below.

In one embodiment, each program used in a strategy is defined by the user. The user inputs to administration 220 via user input/output 202 details about each program. In one embodiment, a program is an application 262, 266. In another embodiment, a program is an application interface 232, 234, described below.

In another embodiment, a program is an application interface 232, 234, described below, that accepts as inputs a type of database 264, 268 and a type of input record or input file 208 and operates one or more applications 262, 266. The same application interface 232 or 234 may be used in the definition of in several different programs, for example where each program using the same application interface 232 or 234 operates with a different type of database 264, 268 or input record in the input file 208.

In one embodiment, the details input by the user to define a program include the type of computer or operating system on which the program runs, an identifier to be used to refer to the program, the database type and input type used by the program 262, 266, and the application corresponding to the program.

In one embodiment, each program may be assigned by the user a program class identifier, which is shared by other programs that are related to one another but operate in different environments. For example, if a record in an input file can describe a protein or a nucleotide and a database can describe a protein or nucleotide, if each program uses one input type and one database file type, four combinations of input record types are possible. For each of the four type combinations, a different program may be used, however, each of the four programs can be marked with the same program class identifier to allow the controller 200 to select the proper program from among those with the same program class identifier when the strategy is executed. Because the input record or input file is provided by the user at the time the strategy is executed, the type of the input record or file may not be known during strategy definition. Therefore, the use of a program class identifier can allow the controller 200 to make the selection of the proper program when the strategy is executed.

For each program, these details are stored by administration 220 in the program table 286 together or associated together, for use as described below.

In one embodiment, the user similarly defines the parameter sets used by a strategy. The user inputs to the administration 220 via user input/output 202 the name of each parameter set, and the parameters corresponding to the set. These parameters can include any values that manipulate the execution of the program. For each parameter set, administration 220 stores together or associated together in parameter table 288 the name of the set and the parameters input.

c. Strategy Definition

Referring now to FIGS. 2A and 3B, in one embodiment, each strategy is defined by a user using a graphical user interface presented to the user by administration 220 via user input/output 202. Administration 220 allows the user to name the strategy, specify one or more database files 264, 268 to be used by the strategy steps requiring an database file and to define one or more strategy steps to form a strategy.

The user assigns a name to the strategy, and if the strategy name is not unique, administration 220 informs the user that he can either change the name of the strategy or that the former strategy of the same name will be erased and replaced with the strategy defined. Administration 220 opens a file or reserves an area of strategy storage 224 using the name assigned, and stores the strategy definition in the strategy file. Strategy storage 224 may be any storage device such as a disk or memory or a combination of such storage devices. In another embodiment, strategies and definitions are stored in a relational database file.

The user next defines the strategy steps via user input/output 202 coupled to administration 220. In one embodiment, the step number is assigned by administration 220 so that each step number is a consecutive number beginning with the number “1” and unique within the strategy. Referring momentarily to FIG. 3A, the user can insert the program name 312, the database name 314, the parameter name 316 any condition 320 and the action 322 and any alternate action 324 into each strategy steps using conventional graphical user interface data input arrangements.

In one embodiment, some or all of the information input into the strategy is performed via conventional pull down list boxes to restrict the user from inserting information which has not already been defined as described above. Because the components of each strategy are defined and stored separately from the strategy, the components may be reused in multiple strategies.

In other embodiments, the user or administration 220 can assign an icon to the step, and the strategy steps are defined using a graphical user interface, with each strategy step graphically joined to a condition or to a step for unconditional actions. The graphical join is made by the user by drawing a line on the screen between condition or the step and the next step. Administration 220 internally assigns a unique step number to each step as described above and stores the actions based on the step numbers corresponding to the steps joined graphically as described above.

4. Application Interfaces

As described below, each strategy step executed by the controller 200 causes one or more applications 262, 266 corresponding to the programs specified in each step to be executed. In one embodiment, applications 262, 266 are not operated directly by the controller 200. Instead an application interface 232, 234 is used to control the operation of the application 262, 266 under direction of the controller 200.

One purpose of the application interface 232, 234 is to adapt the command and input requirements of the corresponding application to a standard command interface and standard input formats for each of the applications 262, 266. In such a modular approach, the application interface 232, 234 frees the remainder of the controller 200 from addressing the details and differences of each application 262, 266.

As described below, for each strategy step executed, the controller 200 builds a program object for the program and makes it available to the application interface 232, 234. The program object has all of the information required for the application interface 232, 234 to execute the application or applications corresponding to the program specified in the strategy step. In one embodiment, the program object contains some or all of the information in the step being executed and the name and location of the input records or input file or files for the strategy. Because some of the information in the object may be defined in tables 282, 284, 286, 288, in one embodiment, application interface 232, 234 is coupled (not shown) to administration storage 222 to obtain any information defined in the tables in administration storage 222 that the application interface 232, 234 requires. In another embodiment, the program object creator 252 obtains from the tables 282, 284, 286, 288 in administration storage all of the information corresponding to the elements of the strategy step being executed, and includes this information in the program object it builds and sends to the application interface 232, 234. As described below, in one embodiment application interfaces 232, 234 build the program object, and the program object creator 252 performs the other functions as described below.

In one embodiment, a program object, described below, is built by the controller 200 for each program described by a strategy step, and the program object is passed to the application interface 232 for execution. The program object contains all of the information necessary for the program to execute using the correct files such as input and/or database files. In one embodiment, the program object contains the name, type and location of any input record or input file and database files 208, 264, 268 to be processed by the application 262, 266 controlled by the application interface 232. The program object can also specify that an output from one application is to be piped by the operating system to the input of another program.

The application interface 232 reads the program object and places the information to be sent to the application 262, 266 in the format required by the application 262, 266, provides the command to the operating system 206 to execute the application 262, 266. The application interface 232, 234 can then retrieve the results of the application 262, 266 via operating system 206 and, if necessary, reformats the results provided by the application 262, 266 using a standardized format of the controller 200 so that some or all of the results may be interpreted and stored by the controller 200 using a common format. Each application interface 232, 234 is custom programmed to implement the functions described below for the application controlled by the application interface 232, 234.

In another embodiment, the strategy steps and definitions reside in a database file, and the application interface 232 accesses the information to build the program object at the time the strategy step is executed as described below.

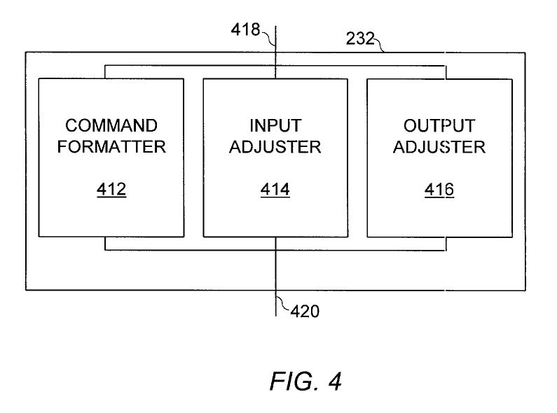

Referring now to FIGS. 2 and 4, one embodiment of an application interface 232 is shown. The application interface 232 contains a command reformatter 412, an input adjuster 414 and an output adjuster 416 described below.

a. Command Formatter

In one embodiment, command formatter 412 accepts a program object via input/output 418 and formats the information in the program object into a command in the format used by the application 262, 266 the application interface 232 controls. In another embodiment, strategy storage 224 and administration storage 222 is a database. Command formatter 412 receives an identifier describing the location in the database of the strategy step to be executed, and command formatter 412 retrieves from the database the additional information necessary to build the program object and builds the program object itself. If the type of the files 208, 264, 268 define a format consistent with the file format required by the application 262, 266 controlled by the application interface 232, application interface 232 builds a command line or a command line and command file that causes the operating system 206 to execute the application 262, 266 in a manner corresponding to the parameters and filenames received. In one embodiment, all files are stored in a consistent format, and so the determination of whether the file requires conversion is embedded into the command formatter 412.

The command formatter 412 sends via input/output 420 the command line built as described above to the operating system 206 to instruct the operating system 206 to execute the application 262, 266 and to provide the command line inputs to the application 262, 266. In one embodiment, the operating system is the conventional UNIX operating system commercially available from Sun Microsystems, Inac., or Silicon Graphics, Inc., of Mountain View Calif., or Digital Equipment Corporation of Manyard, Mass. and the command line is provided by command formatter 412 to the operating system via input/output 420 using a conventional UNIX fork command.

If the application 262, 266 expects keyboard input during execution, command formatter 414 builds a command file using the parameters in the program object and sends the conventional UNIX input/output redirection command to the operating system 206 to redirect the input from a command file in place of the keyboard.

If the application provides output to a display, command formatter 414 may direct the output to a file using conventional UNIX input/output redirection commands.

If the output of one application is used as the input for another, a UNIX pipe command may be used to direct the output of the first application directly into the input of the second.

b. Application Inputs

If any of the files 208, 264, 268 to be provided as inputs to the application 262, 266 are not in the proper format, input adjuster 414 reads the file 208, 264, 268 via input/output 420 and produces an output file with the proper format.

To determine whether the files 208, 264, 268 are not in the proper format, in one embodiment, the proper format or formats for the input record or input files 208 and database files 264, 268 are stored by input adjuster 414 in a storage device, and input adjuster 414 accepts the program object received by the application interface via input/output 418 and determines whether the files are in a proper format. In another embodiment, command formatter 412 stores the proper format information, 412 makes this determination and signals input adjuster 414 that a conversion is necessary.

If any input or file 208, 264, 268 will be adjusted, input adjuster 414 reads the file or files to be converted via input/output 420, converts the files 208, 264, 268, and stores the result in one or more temporary files. Input adjuster 414 provides the name and location of the temporary file produced to command formatter 412 which builds the command line substituting in the command line or command file the name and location of the temporary file produced in place of the file name and location from which it was produced.

In an alternate embodiment, input adjuster 414 is not used, and administration 220 restricts the user from specifying a strategy step with a file 208, 264, 268 having a format inconsistent with the application corresponding to the program specified in the strategy step. In another embodiment, all files 208, 264, 268 are stored in a standard format, and input adjuster 414 is one or more applications executable using, and coupled to, the operating system. Input adjuster 414 reads one of the files specified in the strategy step being executed, and converts the file from the standard format to the format the application 262, 266 requires. Command formatter 412 includes a command to execute the input adjuster 414 and to pipe the output of the into the input of the application specified by the strategy step as a part of the command that is built to execute the application specified in the strategy step.

c. Results

When the application 262, 266 controlled by application interface 232 competes processing, the operating system will transfer control to the output adjuster 416. Cutput adjuster 416 of application interface 232 retrieves via input/output 420 the results file produced by the corresponding application 262, 266 via operating system 206 and output adjuster 416 reformats the results in a format that is the same across other application interfaces 232. In one-embodiment, each application 262, 266 produces a flat ASCII file containing one set of fields in a certain order for each known sequence compared. Output adjuster 416 identifies the fields based on the position of the information and by looking at certain title information in the file, and arranges the information into predefined fields of one record for each known sequence, and returns the records via input/output 420. If necessary, output adjuster 416 will adjust the results to normalize the results across applications 262, 266 or provide any other post-processing functions.

The normalized, consistent results may be provided to controller 200 via input/output 418 for use as described below. In this manner, controller 200 can utilize the results produced by an application 262, 266 without regard to which application produced it.

In one embodiment, if the results of the application 262, 266 controlled by application interface 232 will not be used by the controller 200, output adjuster 416 may be omitted. For example, if the application 262, 266 controlled by the application interface 232 is a filter application that preprocesses a database 264, 268 prior to use by another application 262, 266, the output of such application might not need to be converted for use by controller 200 because further processing will be performed before controller 200 receives the results for use.

In one embodiment, the output adjuster 416 formats the output into a database file format. In another embodiment, output adjuster 416 builds an object containing the results, and in another embodiment, output adjuster 416 may be directed by controller to create either or both of these two types of outputs.

5. Strategy Execution

Referring again to FIGS. 2A and 2B, in one embodiment, the execution of a strategy involves execution of one or more applications associated with a strategy step using the application interface 232, 234 described above, interpretation of the results provided by the application interface 232, 234, and identification of the next strategy step, if any, to be executed. In one embodiment, strategy interpreter 250 of controller 200 manages these functions for the controller 200.

Either of two sets of embodiments of the present invention may be employed. In one set of embodiments, referred to as the database embodiments, each of the strategy steps or references such as pointers to each strategy step are stored in a database in strategy storage 224 along with a status indicator designating the execution status of the strategy step. As strategy steps are executed, the results of the strategy step are compared with the condition specified in the strategy step, and the status indicator of the step specified in the action or alternate action portion of the step that corresponds with the results is marked to indicate it is ready for execution. The database embodiments allow multithreading as described below.

In another embodiment, referred to as the NextStep embodiments, a storage area referred to as NextStep 256 acts like a program counter in a microprocessor to maintain the step number that is to be executed next. The step number is initialized to “1”. The step in NextStep is executed, results compared according to the step in NextStep, NextStep is adjusted based on the comparison of the results and the action and alternate action of the step, and the method continues until a action, alternate action or step is reached that indicates processing should stop.

Using user input/output 202, the user provides the strategy name to be executed and directs administration 220 to execute the strategy. The user specifies one or more inputs records in the input file 208 or input files 208 against which the strategy is to be run. In one embodiment, only one input file 208 or input record in the input file 208 is specified and all strategy steps in the strategy requiring an input will use the input specified. In another embodiment, multiple input records or input files 208 are specified, and the inputs to b e used by the strategy step are either inferred from the strategy step or specified by the user as a part of the strategy step. In another embodiment, any input record or input file 208 is defined at the time the strategy is run or submitted for operation at a later time. In another embodiment, the input file 208 is a portion of another file. For example, the input file 208 can be a record in a database or a set of records defined by a query that is input by the user to administration 220.

In one embodiment, administration 220 can select a program at or before runtime based on the program class identifier specified in, or inferred from, the strategy step and the input record or input file 208 specified at or before runtime. For example, if the user specifies the database name and an application for a strategy step, a program for the step may be selected by administration 220 by matching the type of input record or input file 208 specified for the strategy, and the application and the type of the database 264 specified for the strategy step with a program that has been defined as described below to use the application, type of input record or input file 208 and type of database, freeing the user from having to perform such a match to define the strategy step.

In another embodiment, administration 220 compares the type of input record, input file 208 or database 264, 268 file specified with the type of file expected by the application 262, 266 and if the types do not match, either identifies another application with the same program class identifier that matches the file types of the files specified, or adds another step before the specified step containing an application that is defined to administration 220 as a filter application that will accept the specified file as an input, convert the file into the format required by the application specified in the strategy step and produce an output file in the format required by the application specified in the strategy step. Administration 220 specifies a temporary file name to the filter application to be used for output of the filter. Administration replaces the file name specified in the strategy step with the temporary file name. Administration adds to the strategy an additional step that follows the step specified by the user and that deletes the temporary file name that is output by the filter application. In another embodiment, the application interface 232, 234 performs these operations to ensure the files used are the proper type.

Administration 220 signals strategy interpreter 250 to execute the strategy having the name input by transmitting an identifier of the location in strategy storage 224 of the strategy corresponding to the name input by the user.

a. Program Operation

Referring now to FIG. 2A, in the NextStep set of embodiments, strategy interpreter 250 uses conventional interpretation techniques to parse and execute each line of the strategy stored in strategy storage 224 corresponding to the location received from administration 220. Strategy interpreter 250 initializes NextStep 256 to an initial value such as “1” and directs program object creator 252 to execute the application associated with the step corresponding to the value in NextStep 256.

In one embodiment, program object creator 252 retrieves step number from NextStep 256 and retrieves from strategy storage 224 the information corresponding to the step number retrieved from operation definition storage 222 and creates a program object described above. In one embodiment, program object creator 252 may retrieve information from the tables 282, 284, 286, 288 corresponding to the information in the strategy step to build the program object.

To operate the application associated with the strategy step, in one embodiment, program object creator 252 transmits the program object to the application interface 232, 234 specified by the program. In one embodiment, each application interface 232, 234 is identified by a unique identifier such as the name of the application 262, 266 controlled by the application interface 232, 234. The program object creator 252 retrieves the application name from the program table 286 and includes the corresponding application name in the program object and broadcasts the program object to all of the application interfaces 232, 234. Each application interface 262, 266 contains the name of each application 262, 266 it controls. The application interfaces 232, 234 scan all program objects transmitted and take the object so identified for it. The application interface information stored in the program storage 286 as described above is retrieved by the operation object creator 252 and used to determine the proper application interface 232, 234 to send the operation object.

In another embodiment, all strategy steps reside in a database in strategy storage 224. When a strategy step is executed, the strategy step is marked for execution in the database. Each application interface 232, 234 scans the database and compares the application described in each strategy step marked for execution with the application or applications it is able to process. If a match is found, the application interface marks the strategy step as being processed, and builds the program object as described above.

Referring now to FIG. 2B, in the database set of embodiments, strategy steps are stored in strategy storage 224 in a database, with a status field in each record. The status field has one of five values, with each value corresponding to a step waiting to be executed, a step that is waiting on another step before it can be completed, a step that is completed, a step that is not to be completed, and a step that has not been properly defined and has resulted in an error message.

When a strategy is executed, the user types the strategy name and name of the input record or input file 208 to administration 220. Administration passes the name of the strategy to program object creator 252. Program object creator 252 parses all of the strategy steps, and assigns an initial value to the status field. Those steps that are ready to be executed unconditionally are assigned a value corresponding to a step waiting to be done, and program object creator 252 builds a program object, that contains a unique reference to identify the step from which the object was created, and appends it to the end of a queue file for execution as described below. Program object creator 252 marks steps that are referred to by other steps as waiting on another step, and marks steps that are not in the flow of execution or those that cannot be parsed as never to be completed.

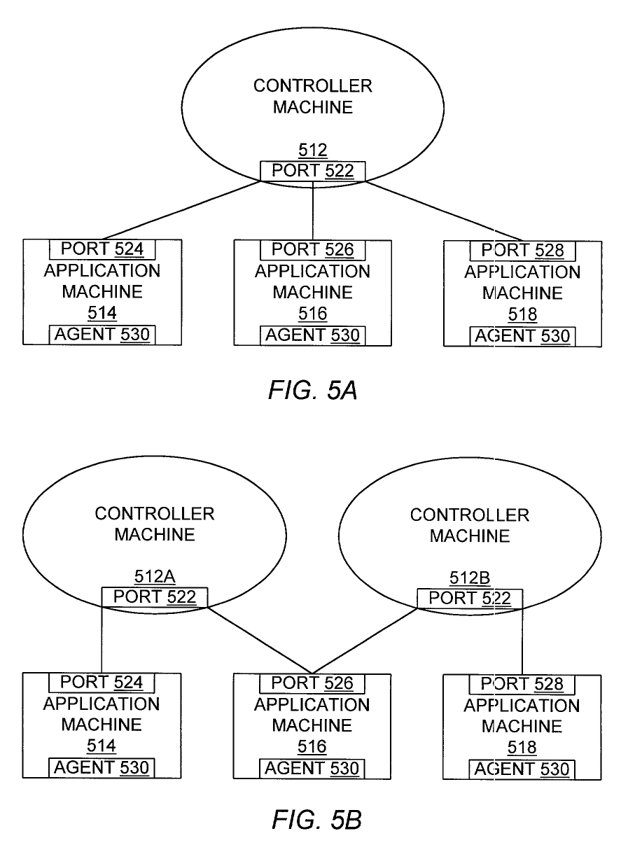

In some of embodiments, one or more applications 262, 266 execute on one or more separate computer systems, allowing computationally intensive applications 262, 266 to be processed simultaneously on the separate computer systems. Referring now to FIG. 5A, an architecture of four computers, referred to as “machines”, arranged according to one embodiment of the present invention is shown. One machine 512, referred to as the controller machine, contains the controller described herein, including changes described below. The other machines 514, 516, 518, referred to as application machines, each contain-one or more applications, and each of which has an agent 530 described below. Each of the machines 512, 514, 516, 518 is a conventional computer system described above and each is coupled in intercommunication to one another via ports 522, 524, 526, 528 such as local area network ports or ports coupled to the Internet.

Referring now to FIG. 2B, in place of the controller sending the command lines to the operating system 206 of FIG. 2A to be executed, the controller 200 appends an indicator describing the execution of one or more applications in the application machines to the end of a file 210 which acts as a queue. In one embodiment, the indicator is a command line. In another embodiment, the indicator is a program object and the application interface 232, 234 for the application resides on the same application machine 514, 516, 518 as the application 262, 266 it controls. In another embodiment, the indicator is a strategy step record in a database, marked for execution as described above. Associated with each such indicator in the queue file 210 is a machine type or other designator that allows an application machine to identify whether it can execute the application to which the indicator is directed.

Referring now to FIGS. 2B and 5A, each of the application machines 514, 516, 518 has loaded by a user one or more of the applications that might be run resulting from a strategy step. In addition, one or more types corresponding to the applications available on the application machine 514, 516, 518 are also input by the user to an agent 530 on each application machine 514, 516, 518 so that the agent 530 can identify which command lines stored in the queue file may be accepted by the application machine 514, 516, 518.

When an application machine 514, 516, 518 is available to perform work, such as when the machine 514, 516, 518 is started or completes execution of an application program, the agent 530 in the agent 530 queries the queue file 210 in the controller machine 512 starting with the oldest indicator in the queue and working sequentially to the newest indicator until it finds an indicator with a machine type associated with the machine 512, 514, 516 of the agent 530. If the agent 530 finds such an indicator, it removes or marks as being processed the indicator from the queue file 210 and executes the application or the program described by the indicator. For example, where the indicator is a command line, agent 530 retrieves the command line from the queue file and provides it to the operating system on the application machine 514, 516, 518 of the agent 530.

In one embodiment, an agent 530 can retrieve indicators from the queue file of multiple controller machines. Referring now to FIG. 5B, five computers 512A, 512B, 514, 516, 518 according to one embodiment of the present invention are shown. The single controller machine 512 of FIG. 5A has been replaced by two controller machines 512A and 512B. In one embodiment, all of the five computers 512A, 512B, 514, 516, 518 are in intercommunication with one another, such as through a local area network. An agent 530 in the application machines may select an indicator from the queue file of either controller machine 512A, 512B, such selection being random among the controller machines 512A, 512B, alternating between the controller machines 512A, 512 or using other selection techniques. In another embodiment, all controller machines 512A, 512B use a single queue file in one of the controller machines 512A, 512B so only one queue file need be selected.

In another embodiment, each controller machine 512A, 512B has its own queue. The controller machines build the program object as described above, and broadcast the program object corresponding to a strategy step to be executed. The controller machines 512A, 512B broadcast the program object to CORBA-compliant middleware, such as VisiBroker commercially available from Visigenic Software, Inc., of San Mateo, Calif. or Orbix commercially available from Iona Technologies, Ltd. Of Cambridge Massachusetts and the middleware handles the execution of the program object and returns the results to be processed as described above. CORBA is described in J. Siegel, et. al, CORBA Fundamentals and Programming, John Wiley & Sons, Inc. 1996.

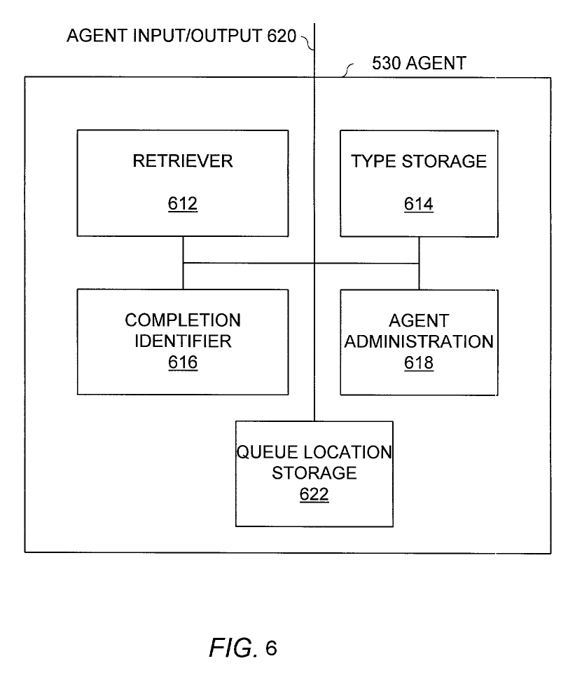

Referring now to FIG. 6, an agent according to one embodiment of the present invention is shown. Agent administration 618 receives user input via agent input/output 620 indicators of the types of applications running on the machine which the agent 530 controls and stores the type indicators in type storage 614. The locations of the queue files the agent 530 is to query are received via agent input/output 620 by agent administration 618 which stores the queue file locations in queue location storage 622. In one embodiment, the user does not communicate with the agent directly, instead communicating with the administration 220 of one or more controllers 200 of FIG. 2B, which format and transmit the information to each agent 530.

Retriever 612 retrieves a queue location from queue location storage 622 selected as described above, and reads the queue file at the location retrieved. Starting with the oldest element in the queue and working sequentially towards the newest, retriever 612 compares the type information in the queue with the type information stored in type storage 614. In other embodiments, other priority techniques including load balancing of the machines on which the applications run may be implemented to select elements from the queue other than oldest element first. If a match is found, retriever 612 retrieves the indicator in the queue and passes it via agent input/output 620 to the operating system to which agent input/output 620 is coupled.

In one embodiment, the indicator is an operating system command line described above. The operating system executes the application as described above. In another embodiment, the indicator is a program object, and the retriever 612 directs the operating system to pass the program object to an application interface residing on one of the application machines such as the machine on which the agent executes.

Completion identifier 616 identifies when the application or applications operated by the indicator have completed, and signals retriever 612 to retrieve another indicator for execution.

If retriever 612 does not locate an indicator having a type matching the type or types stored in type storage 614 from the first queue selected, retriever 612 retrieves another queue location, if any, from queue location storage 622 and repeats the process above for that queue. This process of selection is repeated for all of the queues in queue location storage 622. If no indicators are located after reviewing all queues listed in queue location storage 622, retriever 612 sets a timer to signal a later time at which another attempt at locating an indicator with a matching type should be made.

b. Operation of Conditions

Referring now to FIG. 2A, in the NextStep set of embodiments, either before, during or after the time that the strategy step is being executed, strategy interpreter 250 directs condition interpreter 254 to retrieve any condition in the step having a step number that is in NextStep 256. Condition interpreter 254 uses the step number in NextStep 256 to identify any condition associated with the strategy step. If the condition is unconditional, such as “continue to step N” condition interpreter 254 loads the value of N into the NextStep 256.

If a different condition is associated with the strategy step, condition interpreter 254 builds a condition object describing the condition and passes the object to results manager 240. Results manager 240 interprets the results as described below and signals condition interpreter 254 whether the condition has been met. Based on the signal received from results manager 240, condition interpreter 254 loads NextStep 256 with the step specified in the action 322 or alternate action 324 of FIG. 3A so that execution continues as described in the condition.

For example, if the condition is “If the P score is >1e-50, go to step 5”, condition interpreter builds a condition object corresponding to P score greater than 1e-50, and sends it to the results manager 240 for interpretation of the results. As described below, results manager investigates the results received to identify whether any result record satisfies the condition in the step. If the condition is satisfied, results manager 240 signals as such, and condition interpreter 254 places a value of “5” in NextStep 256. If the condition is not satisfied, condition interpreter 254 adds one to the value in NextStep 256 and stores it back into NextStep, and signals the strategy interpreter 250 to execute the instruction specified by NextStep 256 and the process described above repeats. In one embodiment, conditions may have alternate actions 324 of FIG. 3A if the condition fails, such as “If the P score is >1e-50, go to step 7, otherwise, go to step 8.” If the condition fails as indicated as described below, condition interpreter 254 loads 8 into NextStep 256 and signals strategy interpreter 250 to repeat the process of execution.

If an action or alternate action taken specifies “stop”, condition interpreter 254 signifies that no further strategy steps should be executed by placing a value of “0” into NextStep 256 prior to signaling strategy interpreter 250. Stop can be used as one of the alternative conditions, such as “If the P score is >1e-50, go to step 8, otherwise stop”, or stop may be used in place of the condition, specifying an unconditional end of execution. When strategy interpreter 250 identifies 0 in NextStep 256 when signaled by condition interpreter 254, strategy interpreter 250 then ceases the execution of further applications 262, 266 described above and transfers control to administration 220 which can request additional instructions from the user.

In the database set of embodiments, results are returned by the application or the program to the database manager 246, which stores the results in results storage along with the indicator of the step that caused the results to be returned. Results manager 246 also receives the identifier of the step that caused the results to be generated, and signals condition interpreter 254 the step number of the results that have been returned. Condition interpreter changes the status of the step in strategy storage 224 to show the step has completed, builds the condition object as described above, and passes the condition object to results manager 244, which interprets the results that are stored in the results storage 272 as described below, and signals condition interpreter as described above. Condition interpreter uses the strategy step and the signal from interpreter 244 to determine the strategy step that should be executed corresponding to the strategy step for which the condition was tested and the action and alternate action in the strategy step, and marks this step as ready to be executed. Program object creator 252 periodically scans the strategy steps those marked ready to be executed, marks the step as in process and builds the program object for the step as described above.

c. Results Interpretation

Referring now to FIG. 2A, in the NextStep set of embodiments, results are received from application interfaces 232, 234 by the results manager 240 which interprets the results, and causes the results lo be stored in results storage 272. In one embodiment, the application interfaces 232, 234 provide results using multiple object records having a format known to the results manager 240. This allows the components 244, 246 of the results manager 240 to identify and interpret the results returned from the various applications 262, 266.

In one embodiment, application interfaces 232, 234, are coupled directly to results storage 272 and all output received from application interfaces 232, 234 are placed in results storage in database format. Results manager interprets the results by querying the results storage database 272.

In one embodiment, applications 262, 266 are gene sequencing algorithms, and the results returned with each sequence comparison contain a separate record for each sequence compared, with each of the records containing an index, a P Score a description of the known sequence compared against, a graphical representation of the known sequence and other data. Interpreter 244 can interpret the results in each object received by results manager 240, and can signal condition interpreter 254 via the input/output connection between them whether a condition is met.

As an example, in one embodiment, results manager receives a condition object as described above that identifies the object variable of interest as the P score, and identifies a condition of “less than” and a value of 1e-50, and passes it to interpreter 244 which reads the condition object and watches the P score in each of the result objects received by the results manager 240 for a P score that satisfies the condition. Interpreter 244 watches the results records passing through results manager on their way to results storage 272 and identifies whether any of the records being stored in results storage 272 have met the condition specified. If an “end of results” record, signifying that no additional results are being sent, is received by results manager 240 from application interface 232, 234 sending the results, results manager 240 signals interpreter 244, and if interpreter 244 has determined the condition has not been satisfied, results interpreter 244 signals condition interpreter 254 that the condition has not been satisfied. Otherwise, results interpreter 244 signals condition interpreter 254 that the condition has been satisfied. As described above, condition interpreter 254 then uses the signal from results manager 240 to load the correct step number into NextStep 256.

The database set of embodiments interpret results as described above.

d. Updates

Referring now to FIG. 2B, in both the database embodiments and the NextStep embodiments, databases 264, 268 are updated periodically by the supplier of the database. In one embodiment, update manager 208 identifies the databases 264, 268 that are updated using the update information stored in database table 284, and directs operating system 206 to retrieve the updated database file using a communications link such as the Internet coupled to port 522. Update manager 208 identifies the database 264, 268 as having been updated by inserting a flag in database table 284.

In one embodiment, administration 220 directs strategy interpreter 250 to rerun strategies stored in strategy storage 224 if any of the databases used by the strategy are updated as described above, and administration 220 then clears the flag in the database table 284 that dentified the database as having been updated. In another embodiment, only the strategy steps corresponding to the updated databases are rerun so that their results are available to the user.

In one embodiment, operating system 206 contains a system clock readable by administration 220 via coupling (not shown) to the operating system 206. Databases are updated overnight before each business day. Administration 220 periodically reads the system clock and the strategies using updated databases are rerun by administration 220 as described above when the system clock read is later than a time stored in administration corresponding to a time shortly after the updated databases are available, so that the latest results of each strategy are available to the user when the user arrives for work in the morning.

6. Storage of Results

In one embodiment, results manager 240 stores the results received from application interfaces 232, 234 into results storage 272 using database manager 246. Database manager 246 stores each of the records of the results as a record in a database in the results storage 272. In one embodiment, database manager 246 assigns an identifier that is unique for each results record received by results manager 240 to the record for identification. Database manager 246 also receives from strategy interpreter 250 and adds to each results record identifiers corresponding to the operation, program, application interface 232, 234 or application 262, 266 that generated the record. In one embodiment, these identifiers correspond to the input record or input file 208, and database file 264 or 268 that was used, and the application 262 or 266 that provided the results. The addition of these identifiers allows a user to distinguish results produced using a particular database 264 or 268, application interface 232, 234 or application 262 or 266.

7. Retrieval of Results

Data output manager 260 presents the results stored in results storage 272 to the user via input/output 202. In one embodiment, data output manager 260 presents fewer than all of the fields in each record in a report, such as a graphical report, of the database so that the presented fields of each record are presented on one or two lines of a display screen coupled to input/output 202. In one embodiment, the presented fields are the identifier assigned to the record described above, the probability score known as the P Score for the record, and a short description of the known sequence corresponding to the record.

In one embodiment, a user can retrieve more or all of the information in the database for a record by positioning a mouse cursor over a portion or all of the area of the displayed information containing the fields of the record and then clicking one of the mouse buttons. The data output manager 260 changes the view presented to the user via input/output 202 from a multirecord table to a single record view in which more details of the record are presented to the user.

In one embodiment, the user may perform any conventional database functions such as searching, sorting or querying the information in the database using data output manager 260. Because results from multiple applications 262, 266 are stored in a consistent format in the results storage 272 database, the database functions may be performed to view or arrange the results from many applications 262, 266 simultaneously. For example, a user can rapidly identify the lowest fifty P Scores from the output of multiple applications 262, 266 using a single sort command to the data output manager 260, rapidly and easily assembling useful information from a large amount of data which may have been produced by multiple applications using inconsistent output formats.

In one embodiment, each of the conventional database commands may be stored in strategy storage 212 as a part of the strategy, to allow even the presentation of the data to be provided automatically. For example, strategy steps can include “Select 50 Records with Lowest Pscore” and “Print Selected Records” to allow the summary information from the fifty most promising sequence comparisons to be printed for review by a scientist. Later, if the information in one or more of the databases 264, 268 is updated, the strategy may be rerun as described above to allow simple updates to the information presented.

Because the identifier of the strategy step that produced the results may be stored with each result data record, data output manager 260 may be coupled (not shown) to strategy storage 224 and administration storage 222 to allow data output manager to display the name of the program or application that created the data when the data is displayed.

8. Methods

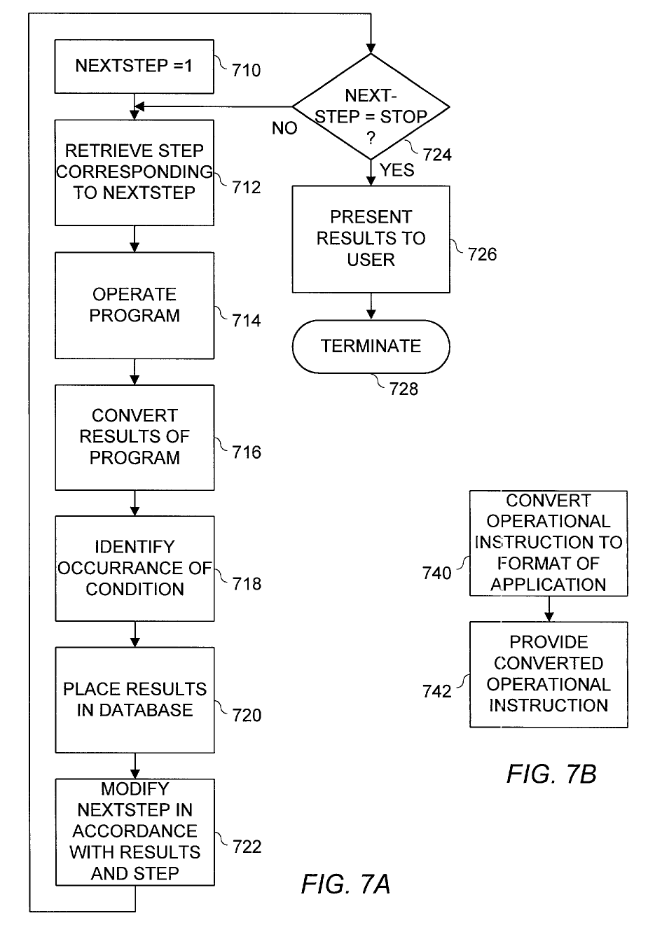

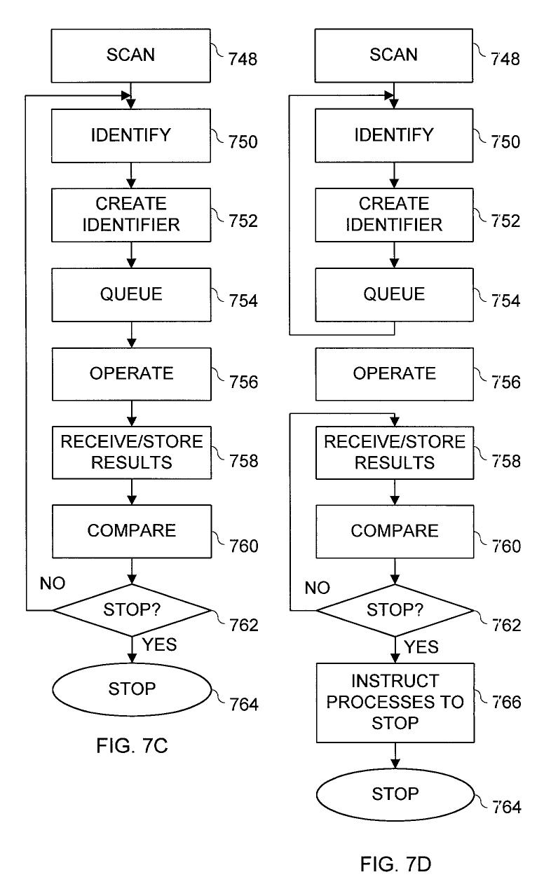

Referring now to FIG. 7A, a method of obtaining results from multiple applications according to one embodiment of the present invention is shown. In one embodiment, strategies contain commands stored in steps as described above, with each step having a unique number signifying the order of storage of the steps. One or more input records or input files are defined for the strategy. A variable, NextStep, may be used to keep track of which step is to be executed next. NextStep is initialized to a value of “1” 710. The step corresponding to NextStep is retrieved 712.

The application or applications described In the step are operated by executing the program 714, which may operate one or more applications. Referring momentarily to FIG. 7B, a method of operating an program according to one embodiment of the present invention is shown. The operational portion of the step retrieved in 712 and the input record or input file name or names of the strategy are converted to the format required by the program 740 and provided to an operating system as a command to execute one or more applications corresponding to the program 742. In one embodiment, the parameter inputs to the applications are provided to the operating system in a command line in the order corresponding to that required by the application as described above. Path identifiers and other information may be added to the command line inputs if required by the applications.

Referring again to FIG. 7A, in one embodiment, the results of the program operated in 714 are converted. The results of the program may be the results of ants of the applications operated by the program. The conversion may be performed for any of several purposes. Some of the programs operated in 714 will produce results that are to be processed by other applications before presentation to a user, and the conversion in 716 may be for the purpose of allowing the results of a prior application to be input to a subsequent application. The results of the program may also be converted to provide consistent results among various applications for purpose of interpretation by the method or analysis by the user described herein.

The results of the program may be interpreted to identify the occurrence of a condition specified in the step 718. For example, the results of the application may be interpreted to determine if any conditions specified in the step retrieved in 712 have been satisfied. A specified condition is one that is explicitly stated in the step. For example, a specified condition might be stated as, “If the P score is >1e-50, go to step 5, otherwise stop.” The results of the program operated in 714 are interpreted to determine if the specified condition that the lowest P score of any result record is greater than 1e-50 has been met.

Some or all of the results from the program operated in 714 are stored in a single database 720 that is used to store these results from each of the operations operated in 714 that produces a result that will be viewed by the user as described below. A database is any arrangement of data that logically associates related information.

NextStep is modified in accordance with thus results and/or any conditions specified in the step 722. If no condition is specified, NextStep is incremented by one. If an unconditional condition is specified, for example, “Go to step 9,” the value of 9 is inserted into NextStep and step 718 may be omitted. If a condition specified has been met based on the interpretation of the result in 71B, the step identifier associated with the condition being Let is inserted in NextStep. For example, if the condition is, “If the P score is >1e-50, go to step 5”, 5 is inserted in NextStep if the condition described has been met as described above with reference to 718. If an alternative step is specified for instances of the condition not being met, for example, “If the P score is >1e-50, go to step 5, otherwise, go to step 9”, if the specified condition is not met, 9 is inserted in NextStep.

If the condition in the step indicates that no additional applications are to be operated if such condition is met, and the condition specified is met, a value of 0 or other signal value is inserted into NextStep to indicate that no additional applications are to be operated. In one embodiment, the indication that no additional applications are to be operated is referred to as “stop”. For example, the condition portion of a strategy step can be “stop” to unconditionally stop additional applications from being operated as described above. There may be a condition associated with a stop indication, such as, “If the P score >1e-5, go to step 5, otherwise stop”.

The value of NextStep is tested 724 to determine whether it has a value corresponding to the stop indicator. If NextStep has a value such as zero corresponding to the stop indicator, the user is presented 726 with the results from the applications that were placed in the database in 720 as described above and the method terminates 728. Otherwise, the method repeats at 712.

In one embodiment, the operational instruction provided in 742 is provided to the operating system. The instruction may be provided in such a manner that the operating system executes the instruction to operate the program.

Referring now to FIG. 7C, a method of obtaining results from multiple applications according to an alternate embodiment of the present invention is shown. In one embodiment, the method uses one process, and in another embodiment described below with reference to FIG. 7D, the method uses three processes. Steps are stored in a database, with each step having a status indicator as described above. Steps that are to be operated unconditionally are identified 750 for example by scanning the steps in the strategy 748, parsing all of the instructions, building a representation of some or all of the instructions identified 752 and appending the representation of the steps built to the end of a queue 754 as described above. Steps may also be identified 750 upon receipt of the step identifier or other indication as described below. In one embodiment, the step of placing the conditional branch instruction in the queue includes setting the status of the instruction to “waiting for execution” as described above. In one embodiment, the representation built in step 752 is a program object as described above. In another embodiment, the representation is a handle to the step in the database.

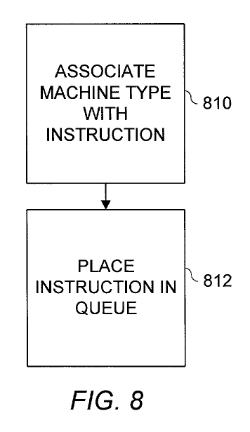

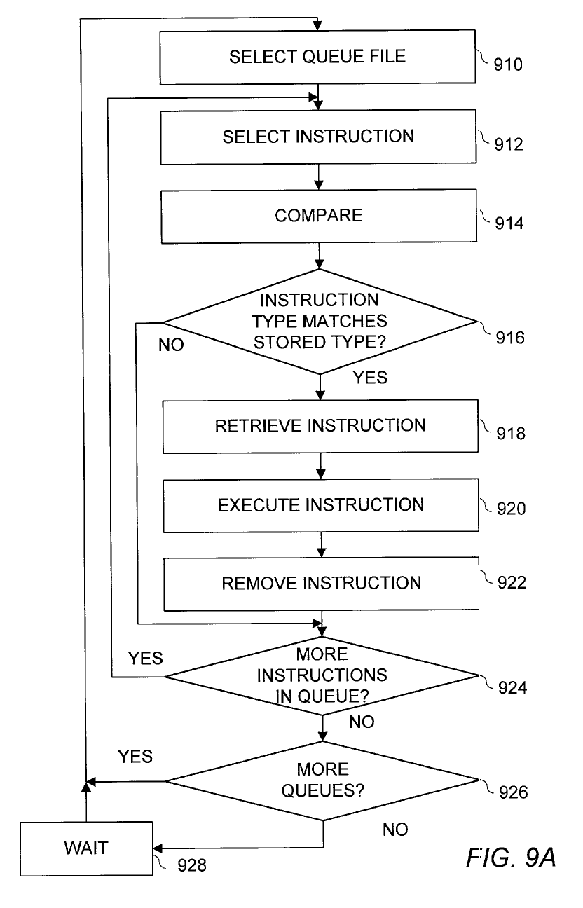

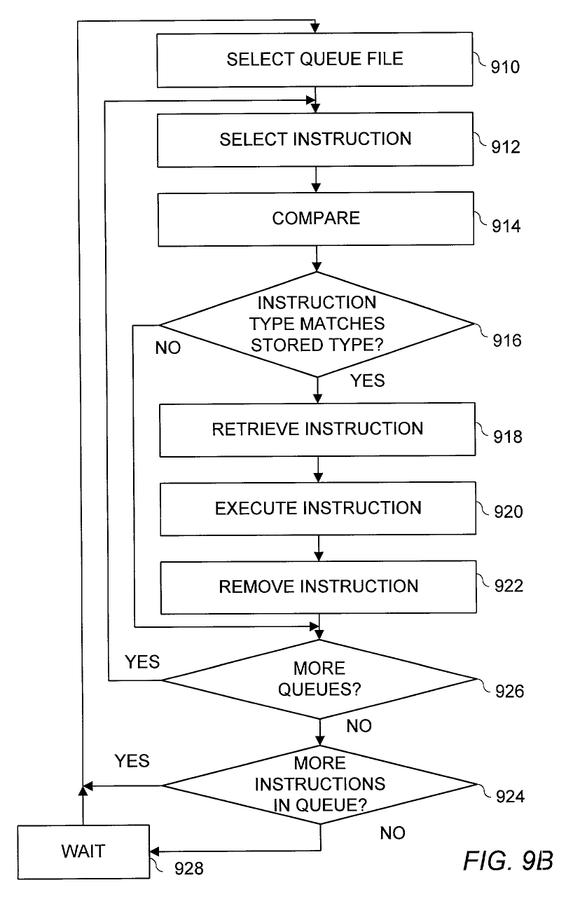

The application or applications described In the step are operated 756 as described below, with any necessary conversions made as described above. In one embodiment the operation step 756 includes operating and executing as described in FIGS. 8, 9A and 9B below.

The results of the one or more applications operated are received and stored as described above 758. In one embodiment, the step of receiving the results includes changing the status of the step that caused the results to be generated to “completed” as described above. The results received in step 758 are compared according to the conditional branch direction 760 as described above, and the step or steps corresponding to the conditional branch direction and the results is or are identified, from the compare step 760 and the steps in the conditional branch instruction of the step corresponding to the step that caused the results to be executed are passed to the identification step 750. In one embodiment, an identifier of the step is passed to the identification step 750. In another embodiment, the status of the step to be executed is set into a “to be executed” state. If the conditional branch instruction is stop or otherwise corresponds to a stop step, the method terminates 762. Otherwise the third process repeats at step 750.

Referring now to FIG. 7D, the steps of FIG. 7C are shown in an alternate embodiment of the present invention. Steps 748, 750, 752 and 754 are run in a first process, step 756 is run by a second process and steps 758, 760, 762, 764 and new step 766 are operated by a third process. The three process method allows the steps in one process to be executed without waiting for the completion of steps in another process. Step 766 instructs the first and second process to terminate in the event that a stop step or conditional branch instruction is reached.

Referring now to FIG. 8, a method of operating an application using an operational instruction according to one embodiment of the present invention is shown. The operational instruction is associated with a machine type which corresponds to a type of machine that can execute the application or applications corresponding to the operational instruction 810. In one embodiment, the association is made by appending a type field to the operational instruction. The operational instruction is placed into a queue 812.

Referring now to FIG. 9A, a method of executing operational instructions according to one embodiment of the present invention is shown. A queue file is selected 910. In one embodiment, the same queue file is always used. In another embodiment, selection 910 is performed among multiple queue files in a round robin, random, or priority weighted random order. An operational instruction is selected 912 from the selected queue. In one embodiment, the operational instruction selected is the operational instruction in the queue for the longest period of time. In another embodiment, the operational instruction is the operational instruction in the queue for the shortest period of time. In one embodiment, the relative length of time an operational instruction has been in the queue may be determined by its position in the queue, with the operational instructions in the queue longest having a position earliest in the queue. The type associated with the operational instruction is compared against a type or type stored 914. If the type associated with the operational instruction matches at least one of the types stored 916, some or all of the operational instruction is retrieved 918 and executed 920 and may be removed from the queue 922. If there are more operational instructions in the queue 924 a different operational instruction is selected 912 and the method repeats beginning from 912. In one embodiment, the selection 912 is the selection of the next operational instruction in the order of thus queue. If there are no more instructions in the queue, if there are other queues 926, another queue is selected 910 as described above and the method repeats. If there are no more instructions in the queue selected and no more queues, a wait period is entered, following which the method repeats at 910.

In another embodiment, other queues, if any, are selected before a second instruction from the same queue is selected, and thus the positions of 924 and 926 are reversed. Referring now to FIG. 9B, such an embodiment is illustrated.

In one embodiment, the queue is managed using a CORBA-compliant process so that the instructions can be executed by any of a number of capable machines as described above.

What is claimed is:

1. An apparatus for executing a plurality of tasks having at least one descriptor comprising:
a queue for storing at least one of the descriptors for each of the tasks;
a queue builder coupled to the queue for providing the descriptors of the plurality of tasks to the queue;
a plurality of agents coupled to the queue for reading the queue, selecting at least one of the descriptors in the queue and providing a representation of the descriptors selected to an output; and
at least one task executor coupled to the output of each of the plurality of agents for receiving the representation of the descriptor and executing the task described by the descriptor corresponding to this descriptor representation received.

2. The apparatus of claim 1 wherein the descriptor the agent selects is an oldest descriptor in the queue.

3. The apparatus of claim 1 wherein each queue has a location and at least one agent comprises:
a queue location storage for storing a plurality of locations of a plurality of the queues; and
a retriever coupled to the queue location storage for selecting at least one of the queue locations from the queue location storage and selecting the queue corresponding to the queue location selected.

4. The apparatus of claim 1 wherein:
the queue builder is additionally for assigning to a plurality of the descriptors at least one type designator designating at least one task executor capable of executing the task corresponding to the descriptor; and
at least one of the agents is additionally for:
providing at least one type designator designating at least one of the task executors coupled to said agent; and
comparing the type designator provided by the agent to at least one of the type designators associated with the descriptor; and
wherein at least one of the agents selects, designators from the at least one queue having a type compatible with the type stored in said agent.

5. The apparatus of claim 4 wherein the agent comprises:
a type storage for providing the at least one type designator designating at least one of the task executors coupled to said agent, each designator having a compatibility with at least one of the type designators; and
a retriever coupled to the type storage for comparing the type designator provided by the type storage to at least one of the type designators associated with the descriptor and selecting designators from the at least one queue having a type compatible with the type stored in said agent.

6. The apparatus of claim 1 wherein each agent is operated by a separate processor.

7. A method of distributed processing of a first set of tasks executable by a first machine and a second set of tasks executable by a second machine different from the first machine, the method comprising:
providing, for each of the tasks in each set of tasks, at least one descriptor containing information about how to execute said task;
storing into a queue a plurality of the descriptors provided for at least one task in the first set of tasks and at least one task in the second set of tasks;
selecting a first set of at least one descriptor stored in the queue;
providing the first set of at least one descriptor selected to the first machine;
selecting a second set of at least one descriptor stored in the queue; and
providing the second set of at least one descriptor selected to the second machine.

8. The method of claim 7 additionally comprising the steps of:
assigning a first type indicator to each of the tasks in the first set;
assigning a second type indicator to each of the tasks in the second set; and
wherein:
selecting a first set of at least one descriptor stored in the queue comprises selecting at least one descriptor stored in the queue assigned the first type indicator; and
selecting a second set of at least one descriptor stored in the queue comprises selecting at least one descriptor stored in the queue assigned the second type indicator.

9. The method of claim 7 additionally comprising the step of selecting the queue from a plurality of queues before selecting the first set of at least one descriptor stored in the queue.

10. A computer program product comprising a computer useable medium having computer readable code embodied therein for distributed processing of a first set of tasks executable by a first machine and a second set of tasks executable by a second machine different from the first machine, the computer program product comprising:
computer readable program code devices configured to cause a computer to provide, for each of the tasks in each set of tasks, at least one descriptor containing information about how to execute said task;
computer readable program code devices configured to cause a computer to store into a queue a plurality of the descriptors provided for at least one task in the first set of tasks and at least one task in the second set of tasks;
computer readable program code devices configured to cause a computer to select a first set of at least one descriptor stored in the queue;
computer readable program code devices configured to cause a computer to provide the first set of at least one descriptor selected to the first machine;
computer readable program code devices configured to cause a computer to select a second set of at least one descriptor stored in the queue; and
computer readable program code devices configured to cause a computer to provide the second set of at least one descriptor selected to the second machine.

11. The computer program product of claim 10 additionally comprising:
computer readable program code devices configured to cause a computer to assign a first type indicator to each of the tasks in the first set;
computer readable program code devices configured to cause a computer to assign a second type indicator to each of the tasks in the second set; and
wherein:
the computer readable program code devices configured to cause a computer to select a first set of at least one descriptor stored in the queue comprise computer readable program code devices configured to cause a computer to select at least one descriptor stored in the queue assigned the first type indicator; and
the computer readable program code devices configured to cause a computer to select a second set of at least one descriptor stored in the queue comprises computer readable program code devices configured to cause a computer to select at least one descriptor stored in the queue assigned the second type indicator.

12. The computer program product of claim 10 additionally comprising computer readable program code devices configured to cause a computer to select the queue from a plurality of queues before selecting the queue from a plurality of queues before selecting the first set of at least one descriptor stored in the queue.
